(19) United States
(12) Patent Application Publication
(10) Pub. No.: US 2021/0086264 A1
(43) Pub. Date: Mar. 25, 2021

(54) SEALING COMPONENT, IN PARTICULAR FOR SEALING A VAPOR CHAMBER WITH RESPECT TO THE SURROUNDINGS OR TWO VAPOR CHAMBERS HAVING DIFFERENT PRESSURES, AND USE THEREOF

(71) Applicant: Siemens Aktiengesellschaft, München (DE)

(72) Inventors: Ralf Bell, Mülheim an der Ruhr (DE); Anett Bergmann, Hattingen (DE); Christoph Bieniakonski, Essen (DE); Marius Busschulte, Voerde (DE); Stephan Ernst, Dinslaken (DE); Bora Kocdemir, Essen (DE); Markus Legenbauer, Essen (DE); Adam Maguire, Oberhausen (DE); Michael Oehmichen, Mülheim an der Ruhr (DE); Daniel Ostwald, Oberhausen (DE); Ulrich Stanka, Essen (DE); Andreas Ulma, Mülheim an der Ruhr (DE); Niclas van der Lest, Essen (DE)

(21) Appl. No.: 16/603,679

(22) PCT Filed: Mar. 14, 2018
(86) PCT No.: PCT/EP2018/056336

§ 371 Date: Oct. 8, 2019

(30) Foreign Application Priority Data
Apr. 10, 2017 (DE) 10 2017 206 065.4

(51) Int. Cl. B22F 3/105; B33Y 80/00

(52) U.S. Cl. CPC B22F 3/1055; F16J 15/0887; B33Y 80/00

(57) ABSTRACT

Provided is a sealing component, in particular for sealing a vapor chamber with respect to the surroundings or two vapor chambers having different pressures, including at least one ring- or ring-segment-shaped main body, which is at least substantially U-shaped in cross-section and which has two end-face walls and a lateral wall connecting the two end-face walls, a support structure being provided within the main body, which support structure connects the two end-face walls to each other.

### CROSS-REFERENCE TO RELATED APPLICATIONS

This application claims priority to PCT Application No. PCT/EP2018/056336, having a filing date of Mar. 14, 2018, which is based on German Application No. 10 2017 206 065.4, having a filing date of Apr. 10, 2017, the entire contents both of which are hereby incorporated by reference.

### FIELD OF TECHNOLOGY

The following relates to a sealing component, in particular for sealing off a vapor chamber from the surroundings or two vapor chambers with different pressures as well as the use thereof.

### BACKGROUND

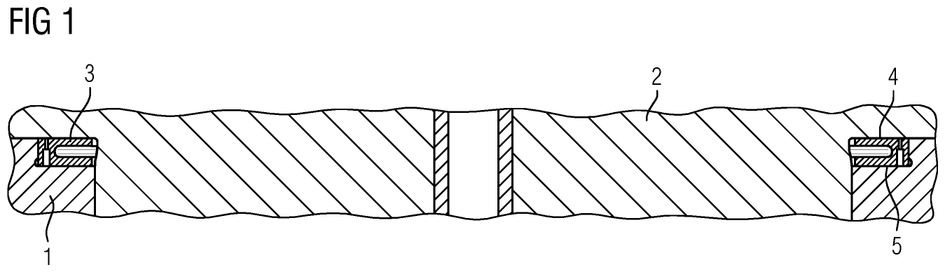

It is known to the applicant that metal rings with a U-shaped cross-section which is open toward the inside are used to seal off vapor chambers with different pressures or also to seal off a vapor chamber from the surroundings. FIG. 1 shows by way of example a partial section through a valve with a valve housing 1 which is closed off by a cover 2, wherein such a metal ring 3 is inserted in an annular gap formed between housing 1 and cover 2 in order to achieve a sealing off of the interior of valve housing 1 from the surroundings.

Comparatively high manufacturing costs and long procurement times which sometimes exceed the length of inspection times are associated with such U-rings. This is particularly the case since forgings are exclusively used for the U-rings. The long procurement times lead to the U-rings having to be ordered in advance and held in stock irrespective of the diagnostic findings. Supplier qualification is furthermore necessary. The U-rings must furthermore generally be provided with oversize and individually adjusted in the course of an inspection, which is associated with not insignificant outlay. Above all, special machine tools are required for rings with a large diameter. A further disadvantage lies in the fact that the U-rings cannot always follow creep deformations of the bearing banks, against which they bear with their lateral sides, and which are also not uniform, which can lead to local leaks, in particular in the case of transient operation.

### SUMMARY

An aspect relates to an alternative sealing component which avoids these disadvantages.

A sealing component, in particular for sealing off a vapor chamber from the surroundings or two vapor chambers with different pressures is described, which comprises at least one annular or ring segment-shaped base body which is at least substantially U-shaped in cross-section and which has two lateral walls and a casing wall which connects the two lateral walls, wherein a supporting structure is provided within the base body, which supporting structure connects the two lateral walls to one another.

The at least one base body quasi forms the outer casing of the sealing component which encloses the supporting structure at two axial edges and at the outer diameter and serves to delimit the pressure differences. This is formed to be open toward the inside, therefore corresponds in particular to an annular (ring segment-shaped) hollow body which does not have a wall which defines the inner casing surface. There can be provided a base body which is closed in the circumferential direction, i.e. is annular, or a plurality of ring segment-shaped base bodies which then, combined to form a ring, preferably form a sealing arrangement.

The supporting structure arranged according to the embodiments of the invention in the at least one base body takes on the carrying properties of the sealing element. The base body can therefore be characterized by significantly smaller wall thicknesses than the U-rings known to the applicant without a supporting structure and the lateral walls of the base body can follow significantly more flexibly even large creep deformations and/or locally varying creep deformations in the region of the bearing banks.

The supporting structure can furthermore be expanded during operation as a result of the operating pressure and thus bring about an additional sealing effect.

The supporting structure arranged according to the embodiments of the invention inside the at least one annular or ring segment-shaped base body can be formed, for example, to be honeycomb-shaped or grid-shaped. Alternatively of additionally, the supporting structure can comprise a plurality of in particular cylindrical supporting elements and/or tubular supporting elements. The supporting structure then has a multiplicity of elements which are characterized by a cylindrical outer contour and are formed either as a solid or hollow body. If the supporting structure has cylindrical and/or tubular supporting elements, it is in particular provided that one axial end of each cylindrical or tubular supporting element is preferably integrally connected to one lateral wall and the other axial end of each cylindrical or tubular supporting element is preferably connected integrally to the other lateral wall of the base body. In a particularly preferred configuration, at least a part of the tubular and/or cylindrical supporting elements extends, in particular all the tubular and/or cylindrical supporting elements extend at least substantially in the axial direction of the annular or ring segment-shaped base body.

It can furthermore be provided that all the cylindrical or tubular supporting elements have the same diameter and/or the same length and/or—in the case of tubular supporting elements—the same wall thickness.

In the case of the sealing element according to the embodiments of the invention, rigidity and in particular pretensioning of the known U-rings are taken on by the supporting structure arranged inside the base body. The supporting structure can be pretensioned during assembly, as a result of which an additional sealing effect is brought about. The compression of the supporting structure represents a new possibility of pretensioning. This can be achieved via a compression of the sealing element according to the embodiments of the invention, in particular by applying axial forces from the outside on the two lateral walls of the base body. The compression capacity of the supporting structure can be controlled, for example, via the angle or the wall thickness of elements in the supporting structure, for example, of walls which define the honeycombs or grids or the tubular and/or cylindrical supporting elements. Depending on the field of use of the sealing components according to the embodiments of the invention, a supporting structure can also be provided which is characterized by a rigidity which limits a pretensioning which is excessive for the field of use.

The sealing component according to the embodiments of the invention is preferably used in such a manner that a higher pressure prevails inside the base body, i.e. where the supporting structure is arranged, than outside the base body. In particular an “inflation” of the base body is then caused during operation and the sealing effect is further facilitated.

In a particularly preferred configuration, the sealing element according to the embodiments of the invention is preferably printed. This is to be understood such that a generative or additive production method, for example, selective laser melting (SLM), is used for the production of the sealing component according to the embodiments of the invention. It has been shown to be particularly suitable if the sealing component according to the embodiments of the invention is manufactured by selective laser melting from the powder bed.

If the sealing component according to the embodiments of the invention is printed, i.e. manufactured by a generative production method, it is quickly available in particular in the case of inspection. No conventional U-rings have to be procured or stored. A further advantage lies in the fact that the sealing component according to the embodiments of the invention can be adapted in a targeted manner to the respective chamber dimensions so that an oversize is not necessary and associated adjustment machining is dispensed with. A further advantage of the generative production lies in the fact that pressure equalization bores can be implemented flexibly into the base body and/or into the supporting structure during the printing process. This can reduce the machining time particularly when using Nimonic materials.

The sealing component according to the embodiments of the invention can be printed as a complete ring with a closed annular base body and a supporting structure arranged therein or in the form of a multiplicity of ring segments to be assembled which respectively comprise a ring segment-shaped base body with supporting structure arranged therein. Production of a non-closed ring, rather a plurality of ring segments may on one hand be expedient if the desired or required dimensioning of the (entire) ring exceeds the pressure or machining space available for generative production. Irrespective of the production by a generative method, segmentation may also be expedient on the grounds of assembly.

One particularly preferred embodiment of the sealing component according to the embodiments of the invention is characterized in that the supporting structure is formed integrally with the two lateral walls. This can in particular be achieved in that a generative production method, for example, selective laser melting, is used to produce the sealing component according to the embodiments of the invention.

The supporting structure can furthermore be rotationally symmetrical in relation to the rotational axis of the at least one annular or ring segment-shaped base body.

A further embodiment is characterized in that the supporting structure is formed such that its rigidity varies in the axial direction. In particular, the rigidity can increase at least in portions as seen from one lateral wall in the direction of the other lateral wall. Alternatively or additionally, the supporting structure can also be formed such that its rigidity varies in the circumferential direction of the base body and/or that its rigidity varies in the radial direction. For example, the rigidity can increase or reduce at least in portions in the circumferential and/or radial direction.

A key advantage of the sealing component according to the embodiments of the invention lies in the fact that its freedom of movement can be adjusted flexibly in particular to the deformation characteristics of the bearing banks via a rigidity, which varies in one or more directions, of the supporting structure. In regions in which large deformations of the bearing banks are to be expected or take place according to experience and a conventional U-ring cannot follow the associated local offset, it is possible in the case of the sealing component according to the embodiments of the invention to design this to be more flexible, deformable in the affected regions. As a result of the flexible configuration of the sealing component according to the embodiments of the invention, the risk of leaks is also reduced in the case of a long operating time which is above all of great advantage in view of ever longer inspection intervals. An in particular locally restricted, improved deformability can be achieved with a locally restricted, lower rigidity of the supporting structure.

In a further development, it can furthermore be provided that at least one lateral wall of the base body is formed to be flat, preferably both lateral walls are formed to be flat.

Alternatively or additionally to a supporting structure being arranged in the base body of the sealing component according to the embodiments of the invention, it can furthermore be provided that the wall thickness at least of one lateral wall of the base body varies in the radial direction and/or in the circumferential direction of the base body. Alternatively or additionally, a particularly reliable sealing action of the sealing component according to the embodiments of the invention can be achieved via a variable wall thickness since the lateral wall(s) can follow a larger bank displacement in the case of nominal operation and pressure.

Nickel-based steel alloys, in particular nickel-based high-temperature steel alloys, or high-alloyed steels with chromium and nickel are tried and tested as materials for the base body and—where present—the supporting structure. Cited examples of nickel-based high-temperature super alloys include those which are known under the brand names Nimonic and as an example of a high-alloyed steel with chromium and nickel X₁₂CrNi₁₈₋₈. Other materials are generally also conceivable in particular depending on the temperature of use.

In terms of the wall thicknesses of the lateral walls and/or the casing wall, these preferably lie in the range from 0.1 to 7 mm, particularly preferably in the range from 0.1 mm to 5 mm. Other values are not, however, ruled out.

In terms of the wall thickness or wall thicknesses of the supporting structure, for example, of cylindrical tube-shaped supporting elements of these and/or of walls of a honeycomb-shaped or grid-shaped supporting structure, this can move in particular in the range from 0.1 to 3 mm.

In particular in the case that a sealing component according to the embodiments of the invention is used in a steam turbine, it has been shown to be expedient in terms of the dimensioning of the base body if its outer diameter is up to approximately 1800 mm and/or its axial extent, i.e. its width is up to approximately 50 mm and/or its height, which coincides with the length of the lateral walls in cross-section when the casing wall is formed to be flat and the lateral walls are oriented radially, is up to approximately 100 mm. These dimensions are to be understood by way of example and other values are thus not ruled out.

A further embodiment of the sealing component according to the embodiments of the invention is characterized in that at least one through-bore is provided in at least one of the two lateral walls and/or in the casing wall. The through-bore(s) serves/serve then in particular as (a) pressure-equalization bore(s).

According to a further particularly preferred embodiment, it is provided that the casing wall is characterized by an undulating cross-section. An undulating surface structure of the casing wall offers, in particular in the case of a pretensioning of the sealing component according to the embodiments of the invention, a greater deformation freedom than a smooth (more rigid) surface. Irrespective of the case of pretensioning, the sealing effect in the axial direction during operation is also increased in that greater flexibility of the casing wall is available since the lateral walls can no longer move and thus also better follow greater deformations of the bearing banks.

In a further development, it can furthermore be provided that a sealing lip which extends in the circumferential direction and in particular across the entire circumference of the base body is provided externally on at least one, preferably on both lateral walls. The sealing action of the sealing component according to the embodiments of the invention can be yet further facilitated by one or two lateral sealing lips.

A further subject matter of the present embodiments of the invention is the use of at least one sealing component according to the embodiments of the invention for sealing off a vapor chamber, in which a vapor pressure prevails, from a further vapor chamber, in which a further vapor pressure different from the vapor pressure prevails, or from a chamber with ambient pressure. Valves, steam turbines, boilers and pressure containers are stated purely by way of example as places of use in which, with a sealing component according to the embodiments of the invention, two vapor chambers can be sealed off from one another or a vapor chamber can be sealed off from the surroundings. Other places of use are, however, not ruled out.

The use according to the embodiments of the invention is preferably such that the external surfaces of the base body are exposed to the lower pressure and the internal surfaces of the base body are exposed to the higher pressure of the two chambers. If the use is carried out in this manner, the base body is “inflated” by the internally higher pressure and a particularly good sealing action can be obtained.

### BREIF DESCRIPTION

Some of the embodiments will be described in detail, with reference to the following figures, wherein like designations denote like members, wherein:

FIG. 1 shows a partial section through a valve sealed off by means of a conventional U-ring;

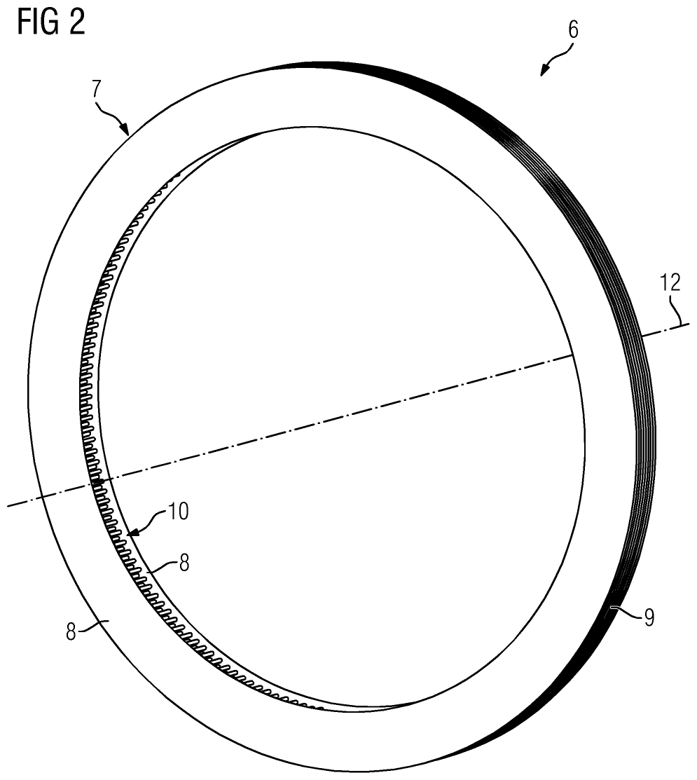

FIG. 2 shows a perspective view of a first embodiment of a sealing component according to the embodiments of the invention with a supporting structure with tubular supporting elements;

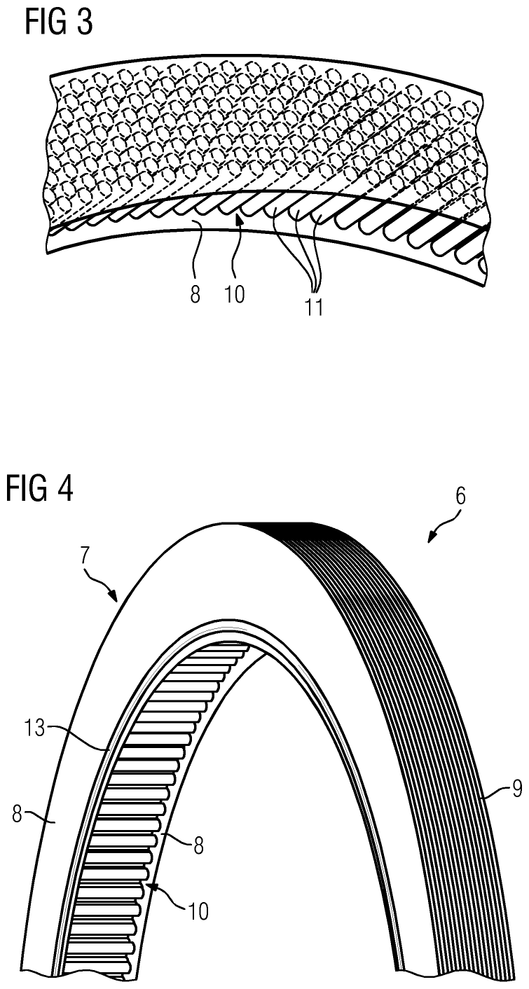

FIG. 3 shows an enlarged perspective partial view of the sealing component from FIG. 2, wherein the front lateral wall is represented to be transparent;

FIG. 4 shows a further ed perspective partial view of the sealing component from FIG. 2,

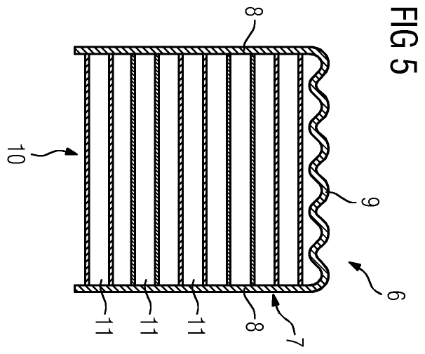

FIG. 5 shows a cross-section through the sealing component from FIG. 2 in a schematic representation;

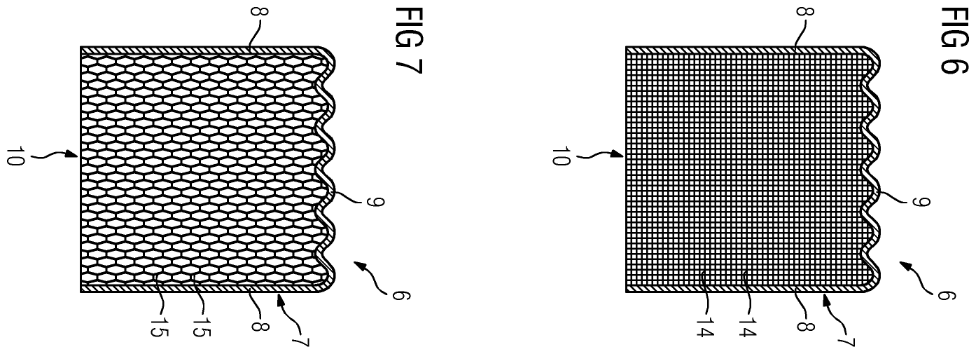

FIG. 6 shows a cross-section through a second embodiment of a sealing component according to the embodiments of the invention which has a grid-shaped supporting structure; and

FIG. 7 shows a cross-section through a third embodiment of a sealing component according to the embodiments of the invention which has a honeycomb-shaped supporting structure.

### DETALED DESCRIPTION

FIG. 1 already cited above shows a metal ring 3 with a U-shaped cross-section which is used in the manner known to the applicant e.g. to seal off the interior of a valve housing 1 closed by a cover 2 from the surroundings. It is characterized by a wall thickness of approximately 5 mm.

Forged U-ring 3 has a comparatively long delivery time and must be procured from qualified suppliers. It was provided with oversize and adapted by subsequent mechanical machining in terms of its outer dimensions to the gap defined between valve housing 1 and cover 2 for receiving thereof. This can furthermore be associated with local leaks in the region of creep deformations, which occur in a non-uniform manner over the circumference of metal ring 3, of bearing banks 4, 5 on cover 2 and housing 1.

These disadvantages are reliably avoided with sealing component 6 according to the embodiments of the invention. A first embodiment of such is represented in perspective in FIG. 2. FIGS. 3 and 4 show enlarged perspective partial views of these sealing components 6 and a cross-section through this is represented schematically in FIG. 5. Sealing component 6 comprises an annular base body 7 which is substantially U-shaped in cross-section and which has two lateral walls 8 and a casing wall 9 which connects two lateral walls 8. The cross-sectional form of base body 7 can be inferred in particular from FIG. 5 which shows a cross-section through base body 7 in the region of one half of sealing component 6.

The outer diameter of annular base body 7 is, in the case of the represented exemplary embodiment, approximately 250 mm and the inner diameter is approximately 190 mm. The axial extent of the base body, i.e. its width is approximately 20 mm and the radial extent in cross-section, i.e. the height is approximately 30 mm. The two lateral walls 8 are formed to be flat and have a consistent wall thickness of approximately 1 mm. As can be inferred in particular from FIG. 5, casing wall 9 is formed to be undulating in cross-section in the case of the represented exemplary embodiment. The wall thickness of undulating lateral wall 9 is also approximately 1 mm. Of course, other values are not ruled out.

A supporting structure 10 is provided according to the embodiments of the invention within base body 7 formed by both lateral walls 8 and casing wall 9.

In the case of the represented exemplary embodiment, supporting structure 10 is formed by a plurality of tubular supporting elements 11 which are arranged in base body 7 and extend in the axial direction and parallel to one another. The term axial direction refers to a direction which coincides with rotational axis 12 of annular base body 7. The wall thickness of tubular supporting elements 11 is approximately 0.7 mm in the present case.

As is apparent in the figures, one axial end of each supporting element 11 is connected to one lateral wall 8 and the respective other axial end is connected to other lateral wall 8 of base body 7. In this case, the connections of supporting elements 11 and lateral walls 8 are integral. This means that base body 7 and supporting structure 10 provided therein form a one-piece component.

The supporting structure can be adapted individually on the basis of the wall thickness and/or the angle of inclination. The angle of inclination is defined by the orientation of supporting elements 11 and lateral walls 8. In the case of the represented exemplary embodiment, supporting elements 11 are, as is apparent in the figures, oriented orthogonally to the two parallel lateral walls 8. Alternatively to this, the supporting elements can also run obliquely through base body 7, i.e. are not oriented orthogonally to the two lateral walls 8. The rigidity can also be influenced via a variation of the angle of supporting elements 11.

The integral formation of base body 7 and supporting structure 10 is due to the fact that sealing component 7 according to the embodiments of the invention was produced by selective laser melting from the powder bed. Base body 7 and supporting structure 10 were jointly constructed in layers. The powder bed here comprised a metal powder composed of a high-alloyed steel with chromium and nickel, concretely X₁₂CrNi₁₈₋₈ or also another suitable material. Base body 7, i.e. lateral walls 8 and undulating casing wall 9 as well as all tubular supporting elements 11 which form supporting structure 10 are correspondingly composed of this alloy.

A sealing lip 13 which extends circumferentially and across the entire scope of base body 7 is furthermore provided externally on both lateral walls 8, which sealing lip 13 was also formed in the course of the selective laser melting from the powder bed for production of sealing component 7. Sealing lips 13 are only represented in FIG. 4, wherein only that sealing lip 13 is apparent which extends on lateral wall 8 which points forward in FIG. 4. An identical sealing lip 13 is provided on the other lateral wall 8, which points backward in FIG. 4, of base body 7. Both sealing lips 13 extend, as is apparent in FIG. 4, close to the inner circumference of lateral walls 8, therefore have a diameter which only slightly exceeds its inner diameter.

Since sealing component 6 has according to the embodiments of the invention a supporting structure 10 arranged in base body 7, which supporting structure 10 takes on the supporting properties of sealing element 6, lateral walls 8 and casing wall 9 can have a significantly smaller wall thickness than U-ring 3 from FIG. 1. If, instead of U-ring 3, sealing component 6 according to the embodiments of the invention as represented in FIG. 1 is used in a valve in order to seal off the inner space of housing 1 from the surroundings with lower pressure, lateral walls 8 of base body 7 can therefore also much more flexibly follow large creep deformations in the region of bearing banks 4, 5 on cover 2 and housing 1. Since, in operation, comparatively thin-walled base body 7 is exposed internally to a higher pressure than on the outside, it ‘inflates’, as a result of which a particularly reliable sealing action is achieved. The undulating configuration of casing wall 9 facilitates a deformation as a result of the internally higher pressure since the undulating form offers greater freedom of deformation than a smooth, more rigid wall.

Since the sealing component was manufactured by printing, concretely selective laser melting from the powder bed, it is—particularly in the case of inspection—quickly available and does not have to be stored for a long time. A required target geometry can furthermore be obtained directly. Subsequent mechanical machining, as is necessary in the case of a forged part with oversize, is dispensed with. As a result of production by a generative method, there is further maximum flexibility in terms of the concrete configuration both of supporting structure 10 and of base body 7.

Two further embodiments of a sealing component 6 according to the embodiments of the invention are represented in FIGS. 6 and 7, wherein—as in FIG. 5 for the first exemplary embodiment—a cross-section through sealing component 6 in the region of one half is shown. The two further embodiments differ from those from FIGS. 1 to 5 solely by a differently configured supporting structure 10. The same components are provided with the same reference numbers.

Concretely, a grid-shaped supporting structure 10 is provided in base body 7 in the case of the second embodiment represented in FIG. 6. Supporting structure 10 is rotationally symmetrical in the circumferential direction in relation to rotational axis 12 of base body 7. In the case of the represented exemplary embodiment, grid walls 14 of supporting structure 10 are oriented parallel or orthogonally to lateral walls 8. Other orientations which do not comprise grid walls 14 which run parallel or orthogonally to lateral walls 8 and/or to one another are also possible.

In the case of the third embodiment according to FIG. 7, a honeycomb-shaped supporting structure 10 which is rotationally symmetrical in the circumferential direction also in relation to axis 12 is provided in base body 7. It also applies in terms of honeycomb walls 15 of this supporting structure 10 that a different orientation to that represented is possible.

In terms of the advantages of the second and third embodiment, the same applies as was explained above for the first embodiment represented in FIGS. 1 to 5.

In contrast to the three exemplary embodiments described here which are characterized by supporting structures 10, the local rigidity of which does not change in the axial, radial or circumferential direction, a rigidity which is changeable in one or more of these directions, i.e. a changeable flexibility, can be provided in a targeted manner. For example, if one is dealing with a particularly pronounced creep deformation of bearing banks 4, 5 in their regions which lie radially further to the outside, the rigidity of supporting structure 10 can be configured to be deliberately lower there and thus the freedom of movement of lateral walls 8 can be configured to be deliberately higher there. This can be achieved, for example, by a smaller wall thickness of tubular supporting elements 11 or grid walls 14 or honeycomb walls 15 in that region of respective supporting structure 10 which lies radially further to the outside. It is also possible that, as an alternative to the three exemplary embodiments described above, the sealing component is not formed in one piece, rather comprises a plurality of segments which respectively have a ring segment-shaped base body with supporting structure arranged therein and, in particular combined to form a closed ring, form a sealing arrangement for the gap between valve housing 1 and cover 2.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A sealing component for sealing off a vapor chamber from surroundings or two vapor chambers with different pressures, comprising:
at least one annular or ring segment-shaped base body which is at least substantially U-shaped in cross-section and which has two lateral walls and a casing wall which connects the two lateral walls, wherein a supporting structure is provided within the base body, and connects the two lateral walls to one another.

2. The sealing component as claimed in claim 1, wherein the supporting structure is formed integrally with the two lateral walls.

3. The sealing component as claimed in claim 1, wherein the supporting structure is honeycomb-shaped or grid-shaped.

4. The sealing component as claimed in claim 1, wherein the supporting structure comprises a plurality of parallel cylindrical supporting elements and/or tubular supporting elements, and one axial end of each cylindrical or tubular supporting element is integrally connected to one lateral wall and the other axial end of each cylindrical or tubular supporting element is connected integrally to the other lateral wall.

5. The sealing component as claimed in claim 1, wherein the supporting structure is rotationally symmetrical in relation to a rotational axis of the base body.

6. The sealing component as claimed in claim 1, wherein the supporting structure is formed such that a rigidity varies in an axial direction and/or the supporting structure is formed such that the rigidity varies in a radial direction and/or the supporting structure is formed such that the rigidity varies in a circumferential direction.

7. The sealing component as claimed in claim 1, wherein at least one lateral wall is formed to be flat.

8. A sealing component for a turbo-machine, comprising; an annular or ring segment-shaped base body which is at least substantially U-shaped in cross-section and which has two lateral walls and a casing wall which connects the two lateral walls, wherein a wall thickness at least of one lateral wall varies in a radial direction and/or in a circumferential direction.

9. The sealing component as claimed in claim 8, wherein the base body and the supporting structure were produced by a selective laser melting from a powder bed.

10. The sealing component as claimed in claim 8, wherein the base body and the supporting structure are composed of a nickel-based steel alloy, a nickel-based high-temperature steel alloy, or a steel high-alloyed with chromium and nickel.

11. The sealing component as claimed in claim 8, wherein the wall thickness at least of one lateral walls and/or the casing wall lies in a range from 0.1 to 7 mm.

12. The sealing component as claimed in claim 1, characterized in that at least one through-bore is provided in at least one of the two lateral walls and/or in the casing wall.

13. The sealing component as claimed in claim 8, wherein the casing wall includes an undulating cross-section.

14. The sealing component as claimed in claim 8, wherein a sealing lip extends in the circumferential direction and across an entire circumference of the base body, the sealing lip provided externally on at least one lateral wall.

15. The use of at least one sealing component as claimed in claim 1 for sealing off a vapor chamber, in which a vapor pressure prevails, from a further vapor chamber, in which a further vapor pressure different from the vapor pressure prevails, or from a chamber with ambient pressure preferably in such a manner that the external surfaces of the base body are exposed to the lower pressure and the internal surfaces of the base body are exposed to the higher pressure.

16. A method comprising:
utilizing at least one sealing component of claim 1 for sealing off a vapor chamber, in which a vapor pressure prevails, from a further vapor chamber, in which a further vapor pressure different from the vapor pressure prevails, or from a chamber with ambient pressure in such a manner that external surfaces of the base body are exposed to the lower pressure and the internal surfaces of the base body are exposed to the higher pressure.
